(19) United States
(12) Patent Application Publication
(10) Pub. No.: US 2015/0002429 A1
(43) Pub. Date: Jan. 1, 2015

(54) HOST APPARATUS, DISPLAY APPARATUS, METHOD OF CONTROLLING HOST APPARATUS, AND METHOD OF CONTROLLING DISPLAY APPARATUS

(71) Applicant: Samsung Electronics Co., Ltd, Suwon-si (KR)

(72) Inventor: Seung-pok LEE, Suwon-si (KR)

(73) Assignee: Samsung Electronics Co., Ltd, Suwon-si (KR)

(21) Appl. No.: 14/318,966

(22) Filed: Jun. 30, 2014

(30) Foreign Application Priority Data
Jun. 28, 2013 (KR) 10-2013-0075791

(51) Int. Cl. G09G 5/00; G06F 3/147; G06F 3/14

(52) U.S. Cl. CPC G09G 5/006; G06F 3/1454; G06F 3/147
USPC 345/173

(57) ABSTRACT

A host apparatus configured to be wirelessly connected to a display apparatus comprising a touch screen includes a graphic processor configured to generate image data that is to be displayed on the display apparatus, a hardware-encoder configured to encode the generated image data, a communication interface unit configured to transmit the encoded data to the display apparatus by using a wireless communication method that uses a preset band and to receive control information corresponding to a control command inputted through the touch screen of the display apparatus, and a controller configured to control the graphic processor to generate the image data corresponding to the control information.

### CROSS-REFERENCE TO RELATED APPLICATIONS

This application claims priority under 35 U.S.C. §119 from Korean Patent Application No. 10-2013-0075791, filed on Jun. 28, 2013, in the Korean Intellectual Property Office, the disclosure of which is incorporated herein by reference in its entirety.

### BACKGROUND OF THE INVENTION

1. Field of the Invention

The present general inventive concept generally relates to providing a host apparatus, a display apparatus, a method of controlling the host apparatus, and a method of controlling the display apparatus, and more particularly, and to providing a host apparatus that has a wide use distance and transmits image data without latency.

2. Description of the Related Art

An apparatus that performs an operation and an apparatus that displays an operation result have been wirelessly connected to each other in order to improve mobility of an electronic apparatus. In detail, a host apparatus transmits computed data, such as image-processed data or the like, to a display apparatus by using a wireless communication technology. Hereinafter, this type of apparatus will be referred to as a wireless detachable apparatus.

In the wireless detachable apparatus, the host apparatus is placed in a fixed position, and the display apparatus is freely used within a range that is supported by communication. Therefore, the wireless detachable apparatus has high mobility and provides a user with differentiated experience.

However, it is difficult for the wireless detachable apparatus to simultaneously satisfy the two following characteristics: transmitting high-resolution image data without latency, and receiving and displaying image data transmitted from the host apparatus while at a significant distance from the host apparatus, for example in a room besides a room where the host apparatus is installed.

In detail, in related arts, high-resolution image data is transmitted by using a high band frequency (for example, 60 GHz). However, if the high band frequency is used, an arrival distance of an electric wave becomes considerably short. Therefore, the display apparatus may not be used in another room beside the room where the host apparatus is installed.

On the contrary to this, if a low band frequency is used in communication between the host apparatus and the display apparatus to allow the host apparatus and the display apparatus to communicate with each other in a wide space, it is difficult to transmit high-resolution image data.

Also, since the wireless detachable apparatus transmits the image data to the display apparatus based on limited wireless resources as describe above, it is difficult to install devices, such as a touch screen and/or a webcam, in the display apparatus.

### SUMMARY OF THE INVENTION

The exemplary embodiments of the present general inventive concept provide a host apparatus that has a wide use distance and transmits image data without latency, a display apparatus, a method of controlling the host apparatus, and a method of controlling the display apparatus.

Additional features and utilities of the present general inventive concept will be set forth in part in the description which follows and, in part, will be obvious from the description, or may be learned by practice of the general inventive concept.

Exemplary embodiments of the present general inventive concept provide a host apparatus configured to be wirelessly connected to a display apparatus including a touch screen, the host apparatus including a graphic processor configured to generate image data that is to be displayed on the display apparatus, a hardware-encoder configured to encode the generated image data, a communication interface unit configured to transmit the encoded data to the display apparatus by using a wireless communication method that uses a preset band and to receive control information corresponding to a control command inputted through the touch screen of the display apparatus, and a controller configured to control the graphic processor to generate the image data according to the control information.

The hardware-encoder may autonomously encode the image data generated by the graphic processor, without control of the controller.

The graphic processor may output the image data and voice data corresponding to the image data as real-time streaming data. The hardware-encoder may encode the real-time streaming data.

The real-time streaming data may be high-definition multimedia interface (HDMI) type data.

The encoder may hardware-encode the generated image data by using a H.264 method.

The wireless communication method may be a 802.11n or 802.11ac method that uses a band of 5 GHz.

The communication interface unit may receive captured data by using the wireless communication method, the captured data being captured by an imaging unit of the display apparatus. The generated image data may include the received captured data.

Exemplary embodiments of the present general inventive concept also provide a display apparatus configured to be wirelessly connected to a host apparatus, the display apparatus including a communication interface unit configured to receive encoded image data from the host apparatus by using a wireless communication method that uses a preset band, a hardware-decoder configured to decode the received image data, a user interface (UI) unit configured to display the decoded image data on a touch screen, and a controller configured to control the communication interface unit to transmit control information corresponding to a control command input through the touch screen to the host apparatus.

The wireless communication method may be a 802.11n or 802.11ac method that uses a band of 5 GHz.

The communication interface unit may receive the encoded image data and encoded voice data corresponding to the encoded image data. The hardware-decoder may decode the encoded image data and the encoded voice data, and the UI unit may display the decoded image data and simultaneously output the decoded voice data.

The display apparatus may further include an imaging unit configured to capture a subject to generate captured data. The controller may control the communication interface unit to transmit the generated captured data to the host apparatus by using the wireless communication method when receiving the encoded image data.

Exemplary embodiments of the present general inventive concept also provide a method of controlling a host apparatus configured to be wirelessly connected to a display apparatus including a touch screen, the method including receiving control information corresponding to a control command inputted through the touch screen of the display apparatus, generating image data corresponding to the control information, encoding the generated image data by a hardware-encoder, and transmitting the encoded image data to the display apparatus by using a wireless communication method that uses a preset band.

The generated image data may be autonomously encoded without control of a controller of the host apparatus.

The generating of the image data may include generating the image data and voice data corresponding to the image data as real-time streaming data. The encoding of the image data may include encoding the real-time streaming data.

The real-time streaming data may be HDMI type data.

The generated image data may be encoded by using an H.264 method.

The wireless communication method may be a 802.11n or 802.11ac that uses a band of 5 GHz.

The method may further include receiving captured data by using the wireless communication method, the captured data being captured by an imaging unit of the display apparatus. The image data may include the received captured data.

Exemplary embodiments of the present general inventive concept also provide a method of controlling a display apparatus configured to be wirelessly connected to a host apparatus, the method including receiving encoded image data from the host apparatus by using a wireless communication method that uses a preset band, decoding the received image data by a hardware-decoder, displaying the decoded image data on a touch screen, and transmitting control information corresponding to a control command input through the touch screen to the host apparatus.

The wireless communication method may be a 802.11n or 802.11ac method that uses a band of 5 GHz.

The receiving of the encoded image data may include receiving the encoded image data and encoded voice data corresponding to the encoded image data. The decoding of the received image data may include decoding the encoded image data and the encoded voice data. The displaying of the decoded image data may include displaying the decoded image data and simultaneously outputting the decoded voice data.

The method may further include capturing a subject to generate captured data, and when receiving the encoded image data, transmitting the generated captured data to the host apparatus by using the wireless communication method.

Exemplary embodiments of the present general inventive concept also provide a host apparatus configured to be wirelessly connected to a display apparatus, the host apparatus including a graphic processor to generate image data, a communication interface unit configured to receive control information corresponding to a control command inputted through a touch screen of the display apparatus, a controller to control the graphic processor to generate the image data corresponding to the control command, and a hardware-encoder to encode the generated image data independent of the controller.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a view illustrating a structure of an electronic system according to an exemplary embodiment of the present general inventive concept;

FIG. 2 is a block diagram illustrating a structure of a host apparatus of FIG. 1;

FIG. 3 is a circuit diagram of a host apparatus that generates image data by using a high definition multimedia interface (HDMI) method;

FIG. 4 is a block diagram illustrating a structure of a display apparatus of FIG. 1;

FIG. 5 is a circuit diagram of a display apparatus that receives HDMI type data;

FIGS. 6 through 8 are views illustrating an operation of an electronic system according to an exemplary embodiment of the present general inventive concept;

FIG. 9 is a flowchart illustrating a method of controlling a host apparatus according to an exemplary embodiment of the present general inventive concept; and

FIG. 10 is a flowchart illustrating a method of controlling a display apparatus according to an exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

The matters defined in the following description, such as detailed construction and elements, are provided to assist in a comprehensive understanding of the exemplary embodiments of the present general inventive concept. Thus, it is apparent that the exemplary embodiments can be carried out without those specifically defined matters. Also, well-known functions or constructions are not described in detail since they would obscure the exemplary embodiments with unnecessary detail.

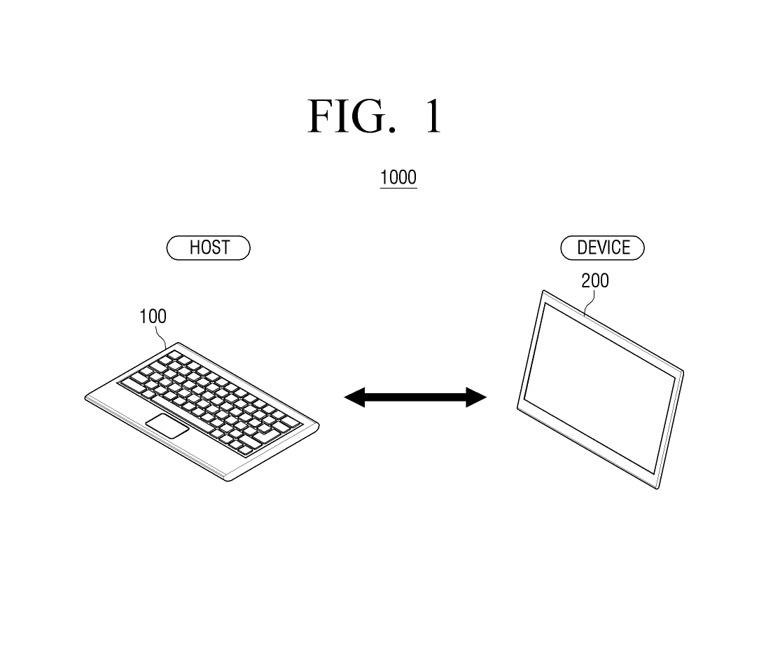

FIG. 1 is a view illustrating a structure of an electronic system 1000 according to an exemplary embodiment of the present general inventive concept.

Referring to FIG. 1, the electronic system 1000 includes a host apparatus 100 and a display apparatus 200.

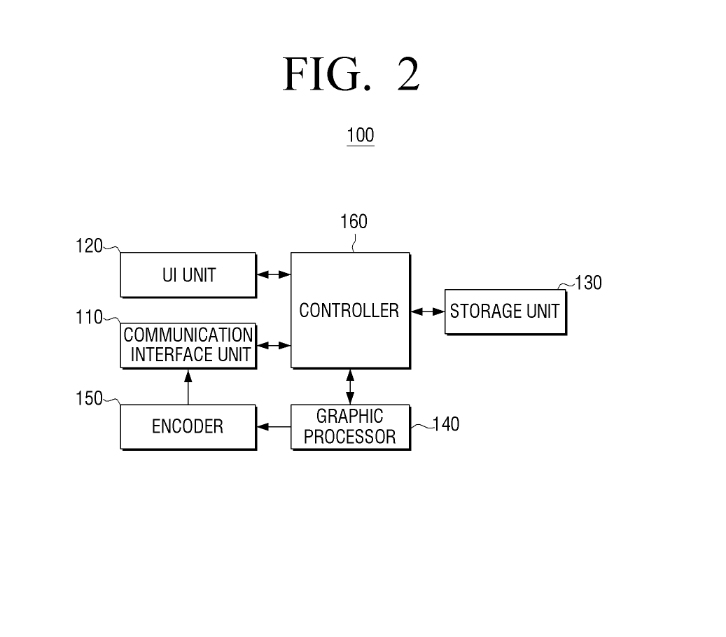

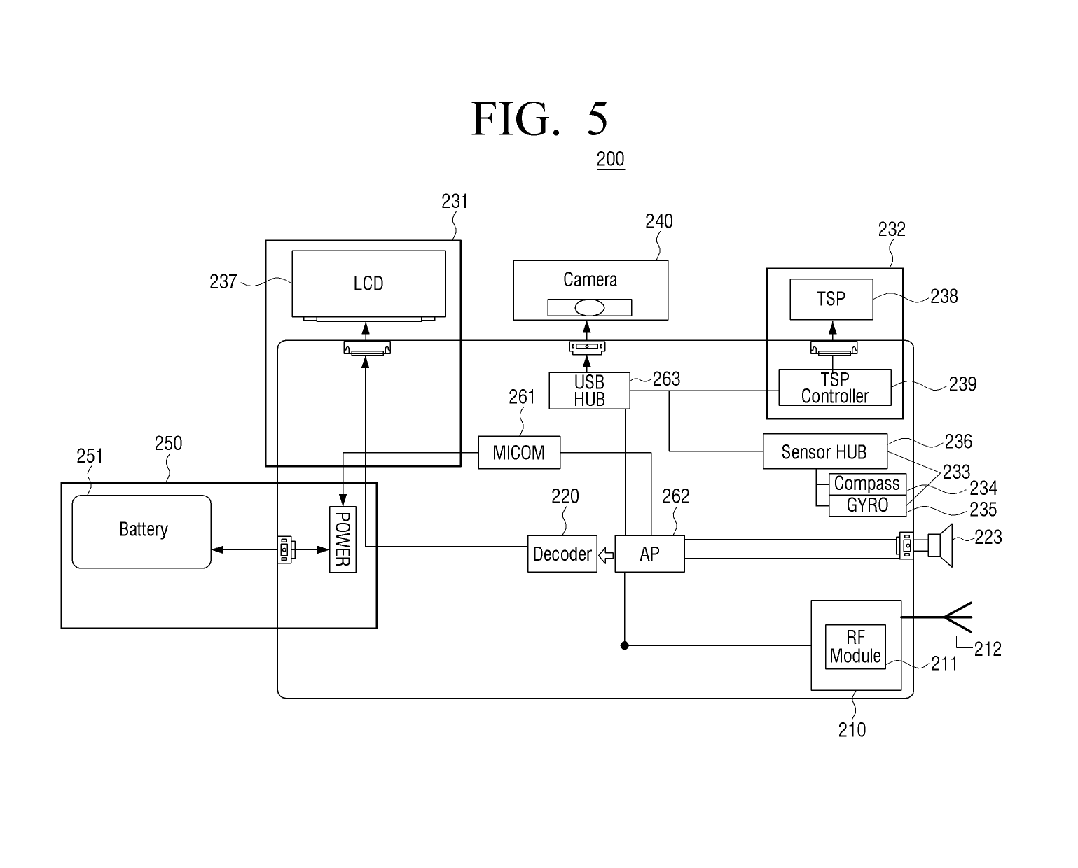

The host apparatus 100 generates image data that is to be displayed on the display apparatus 200, performs hardware-encoding on the generated image data, and transmits the hardware-encoded image data to the display apparatus 200 by using a wireless communication method. The host apparatus 100 may also receive control information input from the display apparatus 200 and captured data that is captured through an imaging unit 240 (illustrated in FIG. 5), such as a webcam, of the display apparatus 200. Detailed operation and structure of the host apparatus 100 will be described later with reference to FIG. 2.

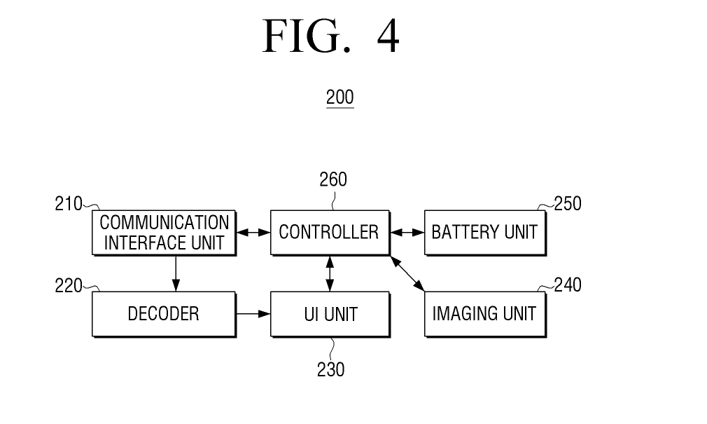

The display apparatus 200 is subordinate to the host apparatus 100 to operate, and receives and displays the image data transmitted from the host apparatus 100 by using a wireless method. In detail, the display apparatus 200 receives the encoded image data from the host apparatus 100 by using a wireless communication method, hardware-decodes the received encoded image data, and displays the decoded image data. The display apparatus 200 may transmit a control command and the captured data to the host apparatus 100, wherein the control command is input from an element such as a touch screen 232 (illustrated in FIG. 5), and the captured data is captured through the imaging unit 240 such as the webcam. Detailed operation and structure of the display apparatus 200 will be described later with reference to FIG. 4.

As described above, the electronic system 1000 according to the present exemplary embodiment of the present general inventive concept encodes and transmits image data. Therefore, the electronic system 1000 may transmit high-resolution image data by using low wireless resources. Also, the electronic system 1000 processes the image data by using a method of encoding hardware that operates separately from a central processing unit (CPU) of the host apparatus 100. Therefore, the electronic system 1000 may transmit the image data to the display apparatus 100 without latency regardless of a load degree of the CPU.

As described above with reference to FIG. 1, the electronic system 1000 may be a detachable PC, or a personal computer with a keyboard detachable from a display screen. Therefore, the display apparatus 200 is subordinate to the host apparatus 100 to operate but may be realized as a type that autonomously operates. In other words, many kinds of apparatus, such as for example a tablet PC, a portable multimedia player (PMP), a smart phone, or the like, may operate as the display apparatus 200 according to the present exemplary embodiment of the present general inventive concept.

FIG. 2 is a block diagram illustrating a structure of the host apparatus 100 of FIG. 1.

Referring to FIG. 2, the host apparatus 100 includes communication interface unit 110, a user interface (UI) unit 120, a storage unit 130, a graphic processor 140, an encoder 150, and a controller 160. The host apparatus 100 may be a main frame of an existing desktop PC or a lower element of a notebook PC, that is, all elements of the notebook PC except a display.

The host apparatus 100 may have a plurality of operation modes. The plurality of operation modes may include a normal mode in which all elements of the host apparatus 100 operate and a sleep mode in which the all elements of the host apparatus 100 operate at lower power consumption than in the normal mode. The host apparatus 100 has only one sleep mode in the present exemplary embodiment of the present general inventive concept, but may include a plurality of sleep modes as operation modes.

The communication interface unit 110 is formed to connect the electronic system 1000 to an external apparatus (not illustrated) through a local area network (LAN) and the Internet or through a wireless communication method (for example, a wireless communication such as Global System/Standard for Mobile Communication (GSM), Universal Mobile Telephone System (UMTS), Long Term Evolution (LTE), WiBRO, Wi-Fi, Bluetooth, or the like). Here, the wireless communication may be a separate wireless communication for communications with the display apparatus 200.

The communication interface unit 110 transmits image data by using a wireless communication method using a preset band. In detail, the communication interface unit 110 may transmit image data, which is hardware-encoded by the encoder 150 that will be described later, to the display apparatus 200 by using a 802.11n (a bandwidth of 300 Mbps) or 802.11ac method (a bandwidth of 1 Gbs) having a band of 5 GHz with a sufficient distance in a home. Here, the communication interface unit 110 may also transmit voice data along with the image data to the display apparatus 200. A Wi-Fi (Wireless LAN) method is used in the present exemplary embodiment of the present general inventive concept, but other types of wireless communication methods that may use the above-described band may be used besides the Wi-Fi method. Also, a band of 5 GHz is used in the present exemplary embodiment of the present general inventive concept, but other bands around 5 GHz may be used.

The communication interface unit 110 also receives a control command from the display apparatus 200. In detail, the communication interface unit 110 may receive a user control command from the display apparatus 200 by using the above-described wireless communication method.

The communication interface unit 110 may transmit and receive control data to and from the display apparatus 200. Here, the control data refers to data that is transmitted between the host apparatus 100 and the display apparatus 200, except the image data and the voice data and may include a user control command input from a user on the display apparatus 200 or the host apparatus 100, an apparatus control command corresponding to the input user control command, state information of the host apparatus 100, state information of the display apparatus 200, etc. Here, the state information may be information about operation modes of the host apparatus 100 and the display apparatus 200, a power state of the display apparatus 200 (in detail, a residual amount of a battery 251, illustrated in FIG. 5), or the like.

The communication interface unit 110 receives captured data from the display apparatus 200. In detail, the communication interface unit 110 may receive the captured data that is captured by an imaging unit 240 of the display apparatus 200, by using a wireless communication method. Here, the captured data may be image data such as JPEG, BMP, or the like or may be video data such as MP4, AVI, or the like. The communication unit 110 receives the captured data including only the image data in the present exemplary embodiment of the present general inventive concept, but the captured data may include voice data.

The UI unit 120 includes a plurality of function keys (not illustrated) through which the user may set or select various types of functions supported by the host apparatus 100. The UI unit 120 may also display various types of information that is provided from the host apparatus 100. The UI unit 120 may be realized as a device that simultaneously realizes an input and an output like a touch screen (not illustrated) or as a combination of an input device such as a mouse or a keyboard (not illustrated) and a display unit (not illustrated) displaying an image. In this case, the UI unit 120 may include a keyboard unit and receive a user control command from the user through the keyboard unit.

As illustrated and described with reference to the drawings, the electronic system 1000 displays an image in the display apparatus 200. However, the host apparatus 100 may further include an element (not illustrated) that displays an image that is the same as or different from the image displayed on the display apparatus 200.

The storage unit 130 stores a program to drive the host apparatus 100. In detail, the storage unit 130 may store a program that is a set of various types of commands necessary to drive the host apparatus 100. Here, the program includes an application program to provide a particular service and an operating program to drive the application program.

The storage unit 130 may store the captured data transmitted from the display apparatus 200.

The storage unit 130 may be realized as an internal storage medium of the host apparatus 100 or an external storage medium, for example, a removable disk including a universal serial bus (USB) memory, a web server through a network, or the like.

The graphic processor 140 generates image data that is to be displayed on the display apparatus 200. In detail, the graphic processor 140 may generate image data corresponding to a user control command input through the display apparatus 200 (or a user control command input through the UI unit 120). Here, the generated image data may be real-time streaming data.

The graphic processor 140 generates only the image data in the present exemplary embodiment of the present general inventive concept but may also generate voice data and video streaming data including image data and voice data together. The video streaming data may be high definition multimedia interface (HDMI) type data.

The graphic processor 140 generates image data including the received captured data. In detail, the graphic processor 140 may generate image data including captured data received through the communication interface unit 110. Here, the graphic processor 140 may use the received captured data as it is or may adjust a size and/or a ratio of the received captured data and the use the adjusted captured data. In other words, the graphic processor 140 may perform image-processing on the received captured data and generate corresponding image data that is to be displayed on the display apparatus 200.

The encoder 150 hardware-encodes the generated image data. In detail, encoding the image data entails compressing the data and converting it to meet proper formats and specifications for playback. The encoder 150 may autonomously hardware-encode the image data output from the graphic processor 140, without control of the controller 160 (in detail, a CPU) that will be described later. That is, the encoder 150 is a dedicated unit which encodes image data without the use of software, which would require a CPU. The encoder 150 may also be called a hardware-encoder. Here, encoding may use a standard H.264 method and may use other encoding methods that deteriorate an image quality or process an image in a sufficient bandwidth besides the standard H.264 method. Since the encoder 150 autonomously encodes the image data without intervention of the controller 160 as described above, latency of transmitted image data is close to 0. Also, since the encoder 150 encodes (in detail, compresses) and transmits the image data, the encoder 150 may transmit a high-resolution image by using Wi-Fi having a bandwidth that is not relatively wide.

The encoder 150 may hardware-encode voice data. In the present exemplary embodiment of the present general inventive concept, the encoder 150 separately encodes image data and voice data. However, if data output from the graphic processor 140 is HDMI data including a voice and an image together, the encoder 150 may simultaneously hardware-encode image data and voice data. In this case, the encoder 150 may code and compress data input through an HDMI according to a bandwidth.

The controller 160 controls elements of the host apparatus 100. In detail, the controller 160 determines an operation mode of the host apparatus 100. In more detail, if an input of the user is not performed for a preset time, and a work is not performed for a preset time, the controller 160 may determine the operation mode of the host apparatus 100 as a sleep mode. Also, if state information notifying that an operation mode of the display apparatus 200 has been changed to a sleep mode is received through the communication interface unit 110, the controller 160 may determine the operation mode of the host apparatus 100 as the sleep mode.

If a wakeup command is received from the user through the UI unit 120 in the sleep mode or state information notifying that the operation mode of the display apparatus 200 has been changed from the sleep mode to a normal mode is received through the communication interface unit 110, the controller 160 may determine that the operation mode of the host apparatus 100 is a normal mode. In the present exemplary embodiment of the present general inventive concept, the operation mode of the host apparatus 100 is changed from the sleep mode to the normal mode or from the normal mode to the sleep mode. However, the operation mode of the host apparatus 100 may be changed from a power off mode to the normal mode when the user turns on the power of the host apparatus 100.

The controller 160 may determine the operation mode of the host apparatus 100 according to a battery state of the display apparatus 200. In detail, if information about a residual amount of a battery 251 of the display apparatus 200 is received as state information through the communication interface unit 110, and the received residual amount of the battery 251 is smaller than a preset residual amount, the controller 160 may determine that the operation mode of the host apparatus 100 is the sleep mode. If the operation mode of the host apparatus 100 is changed to the sleep mode according to the determination, and the battery 251 of the display apparatus 200 is changed into a charge state, the controller 160 may determine that the operation mode of the host apparatus 100 is the normal mode. Information about that the battery 251 of the display apparatus 200 has been changed into the charge state may be received as the above-described state information.

The controller 160 may control the elements of the host apparatus 100 according to the determined operation mode. In detail, if the operation mode of the host apparatus 100 is changed to the sleep mode, the controller 160 may control the storage unit 130 and the graphic processor 140 not to operate in order to operate preset operations.

For example, if the user inputs a power-off command or a command to enter the sleep mode through the UI unit 120, the controller 160 may control the elements of the host apparatus 100 to be in power-on states corresponding to the sleep mode (or a power-off mode). The controller 160 may control the communication interface unit 110 to notify that the operation mode of the host apparatus 100 has been changed. If such information is transmitted to the display apparatus 200, the operation mode of the display apparatus 200 may be changed to the sleep mode or the power-off mode. As described above, the host apparatus 100 according to the present exemplary embodiment of the present general inventive concept transmits information about whether the operation mode of the host apparatus 100 has been changed, as state information to the display apparatus 200. Therefore, the user may simultaneously change states of the host apparatus 100 and the display apparatus 200 by controlling only one device.

If the operation mode of the host apparatus 100 is changed to the normal mode, the controller 160 may control the elements of the host apparatus 100 to wake up elements that do not operate in the sleep mode.

If the operation mode of the host apparatus 100 is changed, the controller 160 may control the communication interface unit 110 to transmit the changed operation mode of the host apparatus 100 as state information to the display apparatus 200.

For example, if the host apparatus 100 is in the sleep mode or the power-off mode, and a wakeup command is input from the user through the UI unit 120, the controller 160 may control the host apparatus 100 to be woken up in order change the operation mode of the host apparatus 100 to the normal mode. In other words, the controller 160 may control the host apparatus 100 to be booted. If an operation system (OS) stored in the storage unit 130 is loaded into a volatile memory to be booted in this process, the controller 160 may control the graphic processor 140 to generate image data through the booting process and image data corresponding to a UI window supported by the OS and control the communication interface unit 110 to wirelessly transmit the generated image data to the display apparatus 200.

Simultaneously with this, the controller 160 informs the display apparatus 200 that the operation mode of the host apparatus 100 has been changed, through the communication interface unit 110. Therefore, the display apparatus 200 may also be woken up without an additional control.

If a first user control command is input through the UI unit 120 (for example, a keyboard unit), the controller 160 may control the graphic processor 140 to generate image data corresponding to the input first user control command. The controller 160 may control the communication interface unit 110 to transmit image data, which is encoded by the encoder 150, to the display apparatus 200.

If a user control command input through the UI unit 120 is a second user control command to control an operation of the display apparatus 200 (for example, an operation change command such as a power-off command, a power-on command, or the like), the controller 160 may control the communication interface unit 110 to transmit control data corresponding to the input second user control command to the display apparatus 200.

If the user inputs a control command through a UI unit 230 of the display apparatus 200 (in detail, a touch screen 232, illustrated in FIG. 5), the display apparatus 200 transmits the input control command as control data to the host apparatus 100. Therefore, if the control data corresponding to the user control command is received from the display apparatus 200 through the communication interface unit 110, the controller 160 may control the graphic processor 140 to generate image data corresponding to the received user control command.

For example, if a command to play a movie file stored in the host apparatus 100 is input through the UI unit 120, the controller 160 may control the graphic processor 140 and the communication interface unit 110 to generate image data of a movie file stored in the storage unit 130 by using a streaming method and transmit the image data to the display apparatus 200. Through this process, if the user inputs an image stop command through the touch screen 232 of the display apparatus 200 when a streaming image corresponding to the movie file is displayed on the display apparatus 200, the display apparatus 200 transmits the image stop command as control data to the host apparatus 100. In this case, the host apparatus 100 may control the graphic processor 140 and the communication interface unit 110 to display an image, which is stopped according to the input image stop command, on the display apparatus 200.

In the above-described exemplary embodiment of the present general inventive concept, a streaming image corresponds to one content (or an output acquired by driving one program). However, the streaming image may be outputs of a plurality of contents. In detail, the user may simultaneously drive a plurality of application programs that are installed in the OS of the host apparatus 100. For example, if the user additionally executes a second application program to play a music content when executing a first application program to surf the Internet (a command to execute such an application program may be input through the touch screen 232 of the UI unit 230 of the display apparatus 200 or through a keyboard or a mouse of the UI unit 130 of the host apparatus 100), the controller 160 may drive the second application program simultaneously when driving the first application program. Therefore, the controller 160 may control the graphic processor 140 to generate a UI window (i.e., image data) to surf the Internet according to the result of driving the first application program and sound data according to the result of driving the second application program and generate real-time streaming data including the generated image data and sound data. The controller 160 may control the communication interface unit 110 to transmit the generated real-time streaming data to the display apparatus 200 by using a wireless communication method.

As described above, the host apparatus 100 according to the present exemplary embodiment of the present general inventive concept hardware-encodes image data and transmits the encoded image data to the display apparatus 200. Therefore, the host apparatus 100 may transmit high-resolution image data by using low wireless resources and receive image data captured by the display apparatus 200 and various types of control data by the same wireless communication method. The host apparatus 100 also uses an encoder 150 that autonomously performs hardware-encoding without control of the CPU and thus may transmit image data to the display apparatus 200 without latency regardless of a load degree of the CPU.

In the above-described exemplary embodiment of the present general inventive concept, the graphic processor 140 and the controller 160 are separate elements but may be realized as one element.

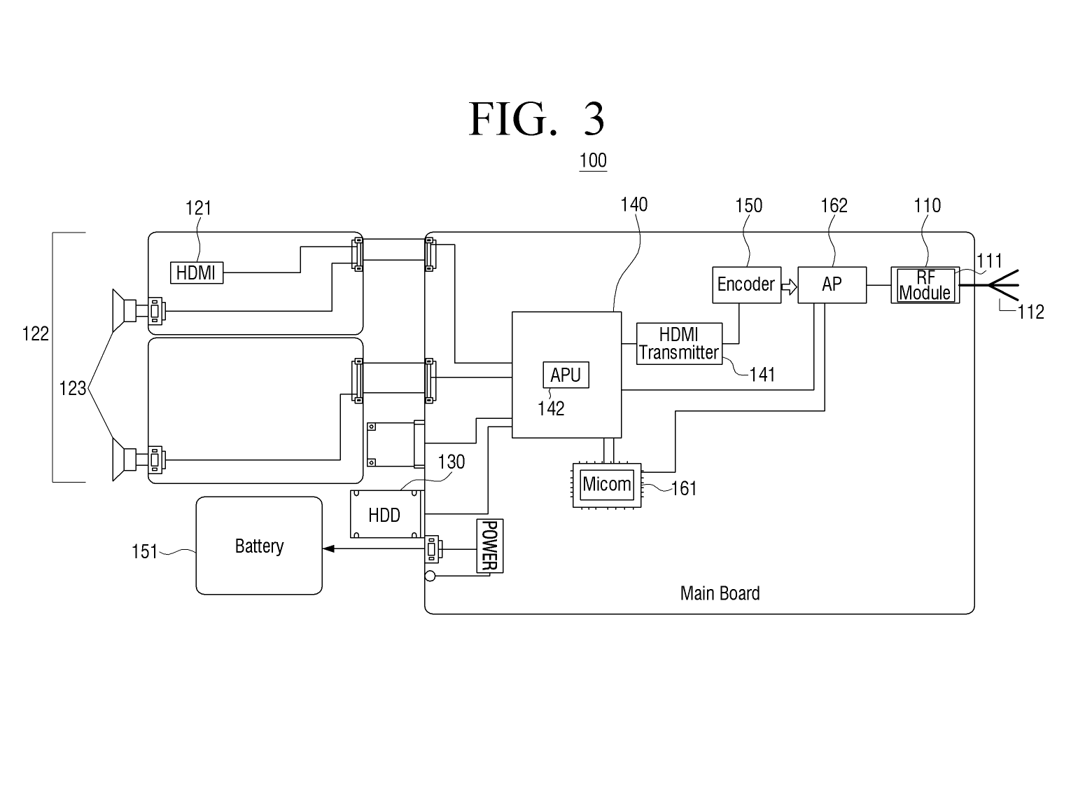

FIG. 3 is a circuit diagram of the host apparatus 100 that generates image data by using an HDMI method.

Referring to FIG. 3, the host apparatus 100 includes the communication interface 110, the UI unit 120, the storage unit 130, the graphic processor 140, and the controller 160.

The communication interface 110 includes a radio frequency (RF) module 111 and transmits data, which is transmitted from an access point (AP) 162, to the display apparatus 200 by using a Wi-Fi method through an antenna 112. The communication interface unit 110 may also receive data from the display apparatus 200 by using a Wi-Fi method and transmit the received data to the AP 162. Here, the RF module 111 may set a bandwidth for communication with the display apparatus 200. In detail, if a band of 300 MHz is used, the RF module 111 may set a band 200 MHz in a lower direction toward the display apparatus 200 and a band of 100 MHz in an upper direction from the display apparatus 200 to the host apparatus 100. The above-described numerical ranges are only an example and thus are not limited thereto. Bandwidths respectively set in the lower and upper directions may vary according to whether the imaging unit 240 of the display apparatus 200 operates.

The UI unit 120 includes an HDMI terminal 121 that outputs an image and a speaker unit 122 that outputs a voice.

The HDMI terminal 121 may output HDMI data, which is output from the graphic processor 140, to an external apparatus. In the present exemplary embodiment of the present general inventive concept, the host apparatus 100 does not display an image but outputs the image to the external apparatus. However, the host apparatus 100 may include a display panel that may display an image.

The speaker unit 122 may output sound data that is output from the graphic processor 140. Two speakers 123 are installed to output surround sound in the present exemplary embodiment of the present general inventive concept, but only one speaker 123 may be installed or three or more speakers 123 may be installed. Speakers 123 are installed in the host apparatus 100 in the present exemplary embodiment of the present general inventive concept but may not be installed in the host apparatus 100. If a speaker 223 (illustrated in FIG. 5) installed in the display apparatus 200 operates, the speakers 123 installed in the host apparatus 100 may not operate. Also, the speaker 223 of the display apparatus 200 may be mixed with the speakers 123 of the host apparatus 100 to be realized as a type that outputs multichannel (for example, 5.1 channel) sound.

The storage unit 130 stores various types of application programs and an operation program for an operation of the host apparatus 100. The storage unit 130 may store captured data transmitted through the communication interface unit 110. A hard disk drive (HDD) is used in the present exemplary embodiment of the present general inventive concept, but a solid state drive (SSD), a flash memory, or the like may be used.

The graphic processor 140 may generate image data corresponding to a control command of a user and output the generated image data by using an HDMI method. The output HDMI data may be transmitted to the encoder 150 through an HDMI transmitter 141. The graphic processor 140 may include an auxiliary processing unit (APU) 142 as illustrated in FIG. 3. The APU 142 may perform some of a function of the graphic processor 140 and a function of the controller 160.

The encoder 150 performs hardware-encoding on the HDMI data transmitted from the graphic processor 140. Since the encoder 150 performs encoding by using the HDMI data as illustrated in FIG. 3, the encoder 150 may operate separately from an operation of the controller 160 of the host apparatus 100 (in detail, operations of a microcomputer, or micom, 161 and the APU 142).

The controller 160 controls the elements of the host apparatus 100. In detail, the controller 160 may include the microcomputer 161 and the AP 162. The controller 160 does not include a CPU in the present exemplary embodiment of the present general inventive concept but may include the above-described elements and a CPU. In other words, in FIG. 3, a function of the CPU that is an element of the controller 160 and a function of the graphic processor 140 may be performed by one element (i.e., the APU 142).

The microcomputer 161 may control the elements of the host apparatus 100 and perform an operation of the controller 161 that has been described in relation to FIG. 3.

The AP 162 controls an operation of the communication interface unit 110. In detail, the AP 162 may control the communication interface unit 110 to transmit image data encoded by the encoder 150 by using a wireless communication method. The AP 162 may control the communication interface unit 110 to receive control data, which is to be transmitted to the display apparatus 200, etc. besides the image data by using a USB method and transmit the received control data to the display apparatus 200.

The AP 162 may transmit captured data, a control command, etc., which are received from the display apparatus 200, to the APU 142 by using a USB method. The AP 162 may adjust a communication bandwidth between the host apparatus 100 and the display apparatus 200 or adjust a ratio between upper and lower bands within a communication band allocated between the host apparatus 100 and the display apparatus 200.

The host apparatus 100 may also include a power supply, for example a battery 151, to supply power to the components of the host apparatus 100.

FIG. 4 is a block diagram illustrating a structure of the display apparatus 200 of FIG. 1.

Referring to FIG. 4, the display apparatus 200 includes a communication interface unit 210, a decoder 220, the UI unit 230, an imaging unit 240, a battery unit 250, and a controller 260.

Here, the display apparatus 200 has a plurality of operation modes. Here, the plurality of operation modes include a normal mode in which elements of the display apparatus 200 operate normally and a sleep mode in which the elements of the display apparatus 200 operate at a lower power consumption than in the normal mode. The display apparatus 200 has only one sleep mode in the present exemplary embodiment of the present general inventive concept but may include a plurality of sleep modes as operation modes, depending on the exemplary embodiment.

The communication interface unit 210 receives image data by using a wireless communication method. In detail, the communication interface unit 210 may receive image data from the communication interface unit 110 of the host apparatus 100 by using a 802.11n method (a bandwidth of 300 Mbps) or a 802.11ac method (a bandwidth of 1 Gbs) having a band of 5 GHz with a sufficient use distance in a home. Here, the communication interface unit 210 may simultaneously receive image data and voice data. Here, the received image data and voice data may be real-time streaming data that is generated by using an HDMI protocol. A Wi-Fi (Wireless LAN) method is used in the present exemplary embodiment of the present general inventive concept. However, besides the Wi-Fi method, other types of wireless communication methods that may use the above-mentioned bands may be used. Also, in the present exemplary embodiment of the present general inventive concept, a band of 5 GHz is used, but other bands around the band of 5 GHz may be used.

The communication interface unit 210 transmits a control command by using a wireless communication method. In detail, the communication interface unit 210 may transmit, a user control command, which is input through the UI unit 230 that will be described later, to the communication interface unit 110 of the host apparatus 100.

The communication interface unit 210 transmits and receives control data with the host apparatus 100 by using a wireless communication method. Here, the control data is data that is transmitted between the host apparatus 100 and the display apparatus 200, except image data and voice data and may include a user control command that is input from the user on the display apparatus 200 or the host apparatus 100, an apparatus control command corresponding to the input user control command, state information of the host apparatus 100, state information of the display apparatus 200, etc. Therefore, the communication interface unit 210 may transmit and receive the state information of the host apparatus 100 and the state information of the display apparatus 200 with the communication interface unit 110 of the host apparatus 100 by using a wireless communication method. Here, the state information may be information about operation modes of the host apparatus 100 and the display apparatus 200, a power state of the display apparatus 200 (in detail, information about a residual amount of a battery 251), or the like.

The communication interface unit 210 transmits captured data to the host apparatus 100. In detail, the communication interface unit 210 may transmit captured data, which is captured by the imaging unit 240 that will be described later, to the host apparatus 100 by using a wireless communication method.

The decoder 220 hardware-decodes the received image data. Similarly to the encoder 150 in the host apparatus 100 described above, the decoder 220 is a dedicated unit which decodes (decompresses) previously encoded image data without the use of software, thereby eliminating the need for a CPU. The decoder 220 may also be called a hardware-decoder. In detail, the decoder 220 may hardware-decode data received by using a decoding method corresponding to an encoding method of the encoder 150 of the host apparatus 100 to output HDMI type data. Here, decoding may use a standard H.264 method and may use other decoding methods besides the standard H.264 method.

The UI unit 230 includes a plurality of functional keys (not illustrated) through which the user may set or select various functions supported by the display apparatus 200, and may display various types of information provided in the display apparatus 200. The UI unit 230 may be realized as a device that simultaneously realizes an input and an output like a touch screen 232 or as a combination of input devices such as various types of buttons and a display unit 231 displaying an image. The UI unit 230 of the display apparatus 200 may be realized as a touch screen 232.

The UI unit 230 displays the received image data. In detail, the UI unit 230 may display image data received through the communication interface unit 210. If data into which image data and voice data are combined is received through the communication interface unit 210, i.e., video streaming data is received, the UI unit 230 may divide the received video streaming data into image streaming data and voice streaming data, display an image corresponding to the image streaming data, and output a voice corresponding to the voice streaming data. The image streaming data and the voice streaming data may be data of one content or data of a plurality of contents. In other words, the image streaming data may be an output of an application program related to surfing of the Internet, and the voice streaming data may be an output an application program related to playing of sound source data.

The UI unit 230 displays state information of the host apparatus 100. In detail, if information notifying that an operation mode of the host apparatus 100 has been changed is received through the communication interface unit 210, the UI unit 230 may display that the operation mode of the host apparatus 100 has been changed. Here, the UI unit 230 may display that an operation mode of the display apparatus 200 has been changed, according to the change of the operation mode of the host apparatus 100.

The UI unit 230 displays a state of a battery 251. In detail, the UI unit 230 may display state information of the battery 251 (for example, whether the battery 251 is being charged, if the battery 251 is not being charged, a current residual amount of the battery 251, information about that a residual amount of the battery 251 is lower than or equal to a preset residual amount, and thus the battery 251 is to be charged, or the like).

The UI unit 230 may include various types of sensors and treats data input from the sensors as control commands. This will be described later with reference to FIG. 5.

The imaging unit 240 captures a subject to generate captured data, and may be for example a camera. In detail, the imaging unit 240 may include a lens (not illustrated) that focuses light of the subject to form an optical image in an imaging area, an imaging device (not illustrated) that converts light incident through the lens into an electrical signal, and an analog-to-digital converter (ADC) that converts an analog signal of the imaging device into a digital signal and outputs the digital signal. Here, the imaging device may be a charge-coupled device (CCD) imaging device or a complementary metal oxide semiconductor (CMOS) imaging device. In the exemplary embodiment of the present general inventive concept, the imaging unit 240 generates captured data including only an image. However, the imaging unit 240 may include a microphone (not illustrated) and generate captured data including voice data that is generated from the microphone.

The battery unit 250 supplies power to elements of the display apparatus 200. In detail, the battery unit 250 includes the battery 251 that stores power and a sensor (not illustrated) that senses a state of the battery 251. The battery unit 250 may supply power to the display apparatus 200 according to an operation mode of the display apparatus 200 under control of the controller 260 that will be described later. The battery unit 250 may be charged by using a wireless charging method.

The controller 260 controls the elements of the display apparatus 200. In detail, the controller 260 determines an operation mode of the display apparatus 200. In more detail, if there is no input of the user for a preset time or the display apparatus 200 does not perform an operation for a preset time, the controller 260 may determine that the operation mode of the display apparatus 200 is a sleep mode. If state information notifying that an operation mode of the host apparatus 100 has been changed to a sleep mode is received through the communication interface unit 210, the controller 260 may determine that the operation mode of the display apparatus 200 is the sleep mode.

If a wakeup command is received from the user through the UI unit 230 in the sleep mode or state information notifying that the operation mode of the host apparatus 100 has been changed from the sleep mode to a normal mode is received through the communication interface unit 210, the controller 260 may determine that the operation mode of the display apparatus 200 is a normal mode.

The controller 260 may determine the operation mode of the display apparatus 200 according to a state of the battery 251 of the display apparatus 200. In detail, if a residual amount of the battery 251 of the display apparatus 200 is smaller than a preset residual amount, the controller 260 may determine that the operation mode of the display apparatus 200 is the sleep mode. If the operation mode of the display apparatus 200 is changed to the sleep mode according to the determination, and the battery 251 of the display apparatus 200 is changed to a charge state, the controller 260 may determine that the operation mode of the display apparatus 200 is the normal mode.

The controller 260 may control the elements of the display apparatus 200 according to the determined operation mode. In detail, if the operation mode of the display apparatus 200 is changed to the sleep mode, the controller 260 may control the communication interface unit 210 to communicate with the host apparatus 100 by using only a wireless communication method. In other words, the controller 260 may control the communication interface unit 210 not to operate or may control only the communication interface unit 210 to operate.

If the operation mode of the display apparatus 200 is changed to the normal mode, the controller 260 may control the elements of the display apparatus 200 to wake up elements of the display apparatus 200 that do not operate in the sleep mode. That is, the controller 260 controls the elements of the display apparatus 200 to receive power from the battery unit 250 according to their normal operations.

If the operation mode of the display apparatus 200 is changed, the controller 260 may control the communication interface unit 210 to transmit the changed operation mode of the display apparatus 200 as state information to the host apparatus 100.

If image data is received through the communication interface unit 210, the controller 260 may control the communication interface unit 210, the decoder 220, and the UI unit 230 to decode the received image and display the decoded image data on the UI unit 230.

If a user control command is received through the UI unit 230, the controller 260 may control the communication interface unit 210 to transmit the user control command as control data to the host apparatus 100.

If a capturing command is received from the host apparatus 100, the controller 260 may control the imaging unit 240 to generate captured data and control the communication interface unit 210 to transmit the generated captured data to the host apparatus 100.

As described above, the display apparatus 200 according to the present exemplary embodiment of the present general inventive concept receives encoded image data and thus may receive high-resolution image data by using low wireless resources. The display apparatus 200 may transmit captured data captured by the display apparatus 200 and various types of control data by using the same wireless communication method.

FIG. 5 is a circuit diagram of the display apparatus 200 that receives HDMI type data.

Referring to FIG. 5, the display apparatus 200 includes the communication interface unit 210, the decoder 220, the UI unit 230, the imaging unit 240, the battery unit 250, and the controller 260.

The communication interface unit 210 includes an RF module 211, receives data from the host apparatus 100 through an antenna 212 by using a Wi-Fi method, and transmits the received data to an AP 262, for example by a USB method. The communication interface unit 210 transmits data, which is to be transmitted to the host apparatus 100, by using a Wi-Fi method. Here, the data to be transmitted may be a control command that is received through the UI unit 230, information that is measured by various types of sensors, or captured data that is generated by the imaging unit 240.

The decoder 220 receives encoded image data from the AP 262 and decodes the received encoded image data. The decoder 220 may output the decoded image data to a display unit 231 by using an HDMI method.

The UI unit 230 includes the display unit 231 that outputs an image, the touch screen 232, a sensor 233, and a speaker.

The display unit 231 may receive HDMI type data from the decoder 220 and display an image by using the received HDMI type data The display unit 231 may be for example an LCD 237.

The touch screen 232 may be disposed on the display unit 231 to transmit a coordinate value of an area touched by the user as a control command to the AP 262. Here, the touch screen 232 may output the control command by using a USB method. The display unit 231 and the touch screen 232 are separate elements in the present exemplary embodiment of the present general inventive concept but may be realized as one device. The touch screen may include a touch screen panel (TSP) 238 to display content and receive inputs, and a TSP Controller 239 to control the display of the TSP and receive the inputs thereon.

The sensor 233 may include a compass 234 and a gyro sensor 235 that sense an arrangement direction and an arrangement position of the display apparatus 200, etc. and output data output from the gyro sensor 235 by using a USB method, for example through a sensor hub 236. The output data of the sensor 233 may be treated as control data to be transmitted to the host apparatus 100 through the communication interface unit 210.

The imaging unit 240 generates captured data having an image and a voice. The imaging unit 240 may be for example a camera. The imaging unit 240 may also transmit the generated captured data to the AP 262 by using a USB method.

The battery unit 250 stores power by using a battery 251 and supplies power to the elements of the display apparatus 200 by using the stored power.

The controller 260 controls the elements of the display apparatus 200. In detail, the controller 260 may include a microcomputer (“micom”) 261, the AP 262, and a USB hub 263.

The microcomputer 261 may control the elements of the display apparatus 200 and perform the operation of the controller 260 that has been described in relation to FIG. 4

The AP 262 controls an operation of the communication interface unit 210. In detail, if data is received through the communication interface unit 210, the AP 262 may determine whether the received data is image data or control data, output the image data to the decoder 220, and transmit the control data to the microcomputer 261.

The AP 262 may control the communication interface unit 210 to receive a control command and captured data through the touch screen 232 by using a USB method and transmit the control command and the captured data.

The USB hub 263 connects the various components of the display apparatus 200 which communicate through a USB method. In the exemplary embodiment of the present general inventive concept illustrated in FIG. 5, the USB hub 263 connects the touch screen 232, the sensor 233, and the AP 262.

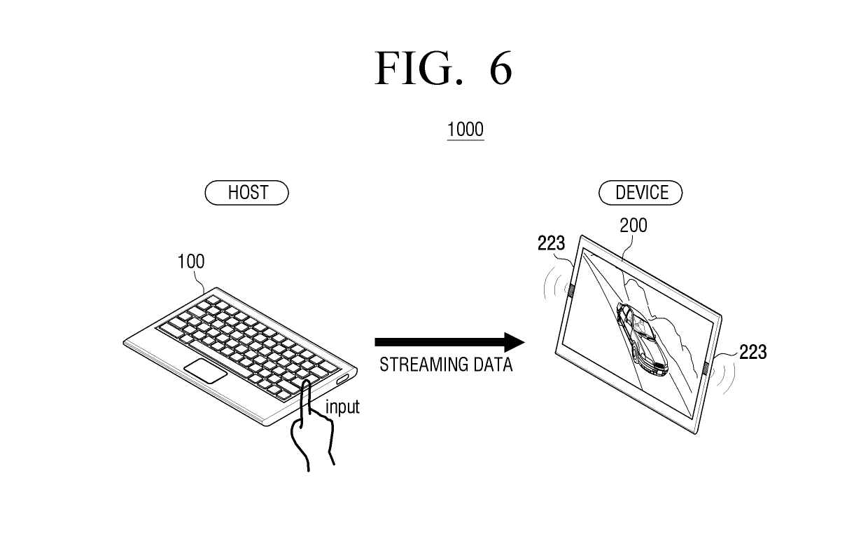

FIGS. 6 through 8 are views illustrating an operation of an electronic system according to an exemplary embodiment of the present general inventive concept.

Referring to FIG. 6, if the user inputs a control command through the UI unit 120 of the host apparatus 100, the host apparatus 100 may generate image data corresponding to the control command, encode the generated image data, and transmit the encoded image data to the display apparatus 200 by using a wireless communication method having a band 5 GHz. The image data transmitted in this process may be real-time streaming data including audio or voice data as illustrated in FIG. 6. As described above, image data may be transmitted by using a wireless communication method having a band of 5 GHz. Therefore, even if the host apparatus 100 and the display apparatus 200 are separated by a distance of 30 m or more, the host apparatus 100 and the display apparatus 200 may communicate with each other. Also, even if a wall exists between the host apparatus 100 and the display apparatus 200, the host apparatus 100 and the display apparatus 200 may still communicate with each other. Also, since the image data is encoded and transmitted, high-resolution image data may be transmitted by using low wireless resources.

The display apparatus 200 receives image data transmitted according to the above-described method and decodes the received image data. The display apparatus 200 may display the decoded image data on a screen and output voice data as a sound.

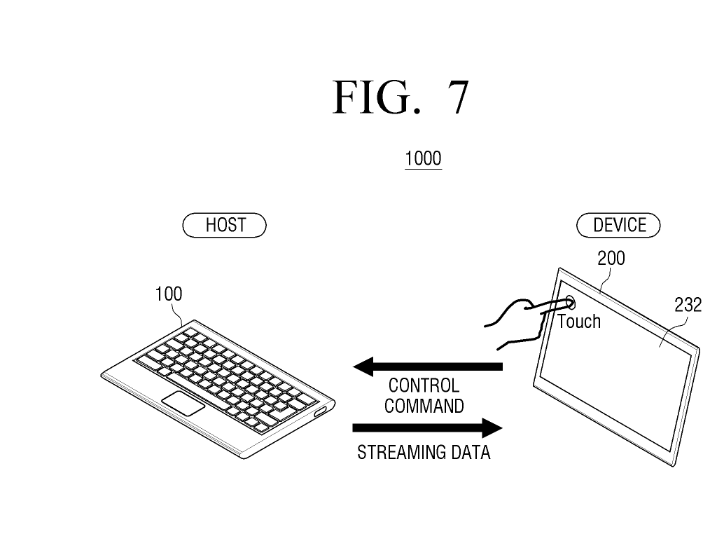

If the user touches the touch screen 232 of the display apparatus 200 in this process, for example, inputs a pause command when a movie is played, the display apparatus 200 may transmit a control command, which is received by using a wireless communication method, to the host apparatus 100 by using a wireless communication method as illustrated in FIG. 7. The transmission of the control command may be performed when receiving image data as described above.

The host apparatus 100 that has received the control command may perform an operation corresponding to the control command. In detail, since the host apparatus 100 receives the pause command from the user, the host apparatus 100 may generate a movie scene paused when the control command is received, encoded the generated image, and transmit the encoded image data.

If a control command of the user is a video chatting command, the display apparatus 200 transmits the control command to the host apparatus 100 by using a wireless communication method. The host apparatus 100 that has received the control command transmits control data, which is to operate the imaging unit 240 of the display apparatus 200, to the display apparatus 200.

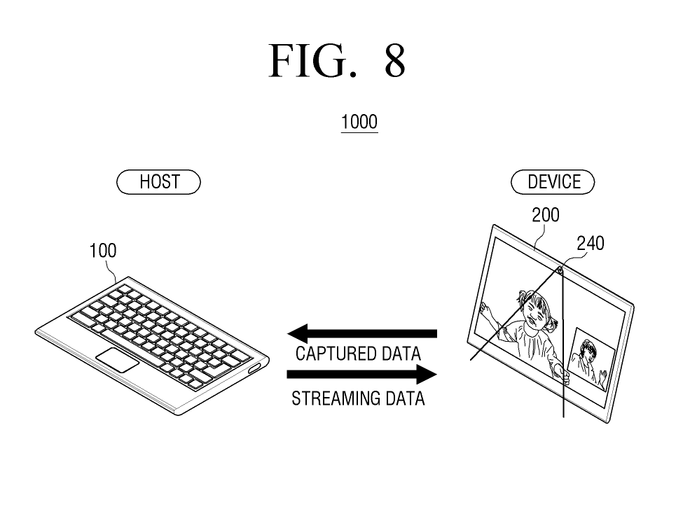

Therefore, as illustrated in FIG. 8, the imaging unit 240 of the display apparatus 200 performs a capturing operation and transmits captured data generated by the capturing operation to the host apparatus 100 by using a wireless communication method.

The host apparatus 100 that has received the captured data generates image data including the received captured data and repeats an operation as described above to transmit encoded image data to the display apparatus 200.

Due to the above-described process, the display apparatus 200 may display an image received from an external apparatus and an image captured by an imaging unit 240 on one screen.

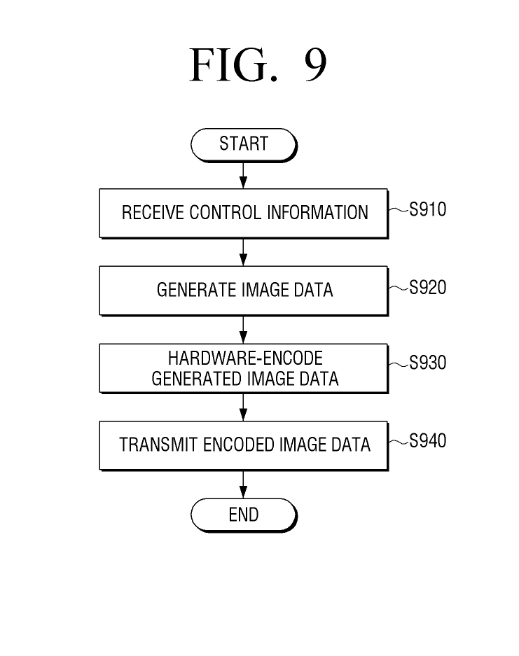

FIG. 9 is a flowchart illustrating a method of controlling the host apparatus 100 according to an exemplary embodiment of the present general inventive concept.

Referring to FIG. 9, in operation S910, the host apparatus 100 receives control information. This control information may be received for example through a touch 232 screen of the display apparatus 200. Alternatively, the host apparatus 100 may directly receive a control command through a UI unit 120 of the host apparatus 100.

In operation S920, the host apparatus 100 generates image data corresponding to the received control command. In detail, the host apparatus 100 may generate image data, which is to be displayed on the display apparatus 200, as real-time streaming data. Here, the host apparatus 100 may generate streaming data including voice data along with the image data. The streaming data may be HDMI type data.

In operation S930, the host apparatus 100 hardware-encodes the generated image data. In detail, the host apparatus 100 may hardware-encode the generated image data by using an encoder 150 that autonomously performs encoding without control of the controller 160 of the host apparatus 100 by a hardware-encoder. Here, encoding may use a standard H.264 method and may use other types of encoding methods that may deteriorate an image quality or process an image in a sufficient bandwidth, besides the standard H.264 method.

In operation S940, the host apparatus 100 transmits the encoded image data by using a wireless communication method using a preset band. In detail, the host apparatus 100 may transmit hardware-encoded image data to the display apparatus 200 by using a 802.11n method (a bandwidth of 300 Mbps) or a 802.11ac method (a bandwidth of 1 Gbs) having a band of 5 GHz with a sufficient use distance in a home. In the present exemplary embodiment of the present general inventive concept, a Wi-Fi method (Wireless LAN) is used. However, other types of wireless communication methods that may use the above-described band may be used besides the Wi-Fi method. Also, in the present exemplary embodiment of the present general inventive concept a band of 5 GHz is used, but other bands around the band of 5 GHz may be used.

In the method of controlling the host apparatus 100 according to the present exemplary embodiment of the present general inventive concept, the host apparatus 100 encodes image data and transmits the encoded image data to the display apparatus 200. Therefore, the host apparatus 100 may transmit high-resolution image data by using low wireless resources and receive image data captured by the display apparatus 200 and various types of control data by using the same wireless communication method. Also, the host apparatus 100 processes the image data by using a hardware-encoding method that autonomously operates without control of a CPU and thus transmit the image data to the display apparatus 200 without latency regardless of processing speed of the CPU. The method of FIG. 9 may be performed on a host apparatus having the structure of FIG. 2 or 3 or on host apparatuses having other types of structures.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include a semiconductor memory, a read-only memory (ROM), a random-access memory (RAM), a USB memory, a memory card, a Blu-Ray disc, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

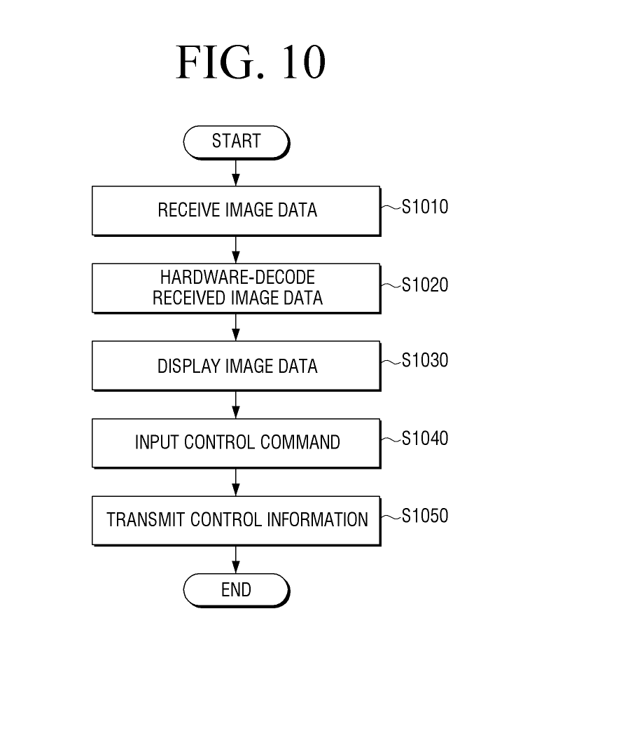

FIG. 10 is a flowchart illustrating a method of controlling the display apparatus 200 according to an exemplary embodiment of the present general inventive concept.

Referring to FIG. 10, in operation S1010, the display apparatus 200 receives image data from the host apparatus 100 by using a wireless communication method that uses a preset band. In detail, the communication interface unit 210 may receive the image data from the host apparatus 100 by using a 802.11 method (a bandwidth of 300 Mbps) or a 802.11ac method (a bandwidth of 1 Gbs) having a band of 5 GHz with a sufficient use distance in a home. In the present exemplary embodiment of the present general inventive concept, a Wi-Fi method is used, but other types of wireless communication methods that may use the above-described band may be used besides the Wi-Fi method. Also, in the present exemplary embodiment of the present general inventive concept, a band of 5 GHz is used, but other bands around the band of 5 GHz may be used.

In operation S1020, the display apparatus 200 hardware-decodes the received image data. In detail, the display apparatus 200 may decode received data by using a decoding method corresponding to an encoding method of the host apparatus 100 and output HDMI type data by a hardware-decoder. Here, decoding may use a standard H.264 method and may use other types of decoding methods besides the standard H.264 method. If the received data is HDMI type data into which image data and voice data are combined, the display apparatus 200 may divide the received data into image data and voice data and decode the image data and the voice data.

In operation S1030, the display apparatus 200 displays the decoded image data by using a touch screen 232. If the received data is data into which image data and voice data are combined, i.e., video streaming data is received, the display apparatus 200 may display the decoded image data and simultaneously output the decoded voice data through a speaker.

In operation S1040, a control command is input through the touch screen 232 to the host apparatus 100. In operation S1050, the display apparatus 200 transmits control information corresponding to the input control command. In detail, the transmission of the control information may be performed simultaneously when the above-described image data is received.

Therefore, in the method of controlling the display apparatus 200 according to the present exemplary embodiment of the present general inventive concept, the display apparatus 200 receives encoded image data. Therefore, the display apparatus 200 may receive high-resolution image data by using low wireless resources and transmit captured data captured by the display apparatus 200 and various types of control data by using the same wireless communication method. The method of FIG. 10 may be performed on a display apparatus 200 having the structure of FIG. 5 or 6 or on display apparatuses 200 having other types of structures.

Similarly to FIG. 9, detailed above, the above-described method may be realized as a program (or an application) including an executable algorithm that may be executed in a computer, and the program may be stored and provided on a non-transitory computer-readable medium.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A host apparatus configured to be wirelessly connected to a display apparatus comprising a touch screen, the host apparatus comprising:
a graphic processor configured to generate image data that is to be displayed on the display apparatus;
a hardware-encoder configured to encode the generated image data;
a communication interface unit configured to transmit the encoded data to the display apparatus by using a wireless communication method that uses a preset band and to receive control information corresponding to a control command inputted through the touch screen of the display apparatus; and
a controller configured to control the graphic processor to generate the image data according to the control information.

2. The host apparatus of claim 1, wherein the hardware-encoder autonomously encodes the image data generated by the graphic processor, without control of the controller.

3. The host apparatus of claim 1, wherein:
the graphic processor outputs the image data and voice data corresponding to the image data as real-time streaming data; and
the hardware-encoder encodes the real-time streaming data.

4. The host apparatus of claim 3, wherein the real-time streaming data is high-definition multimedia interface (HDMI) type data.

5. The host apparatus of claim 1, wherein the hardware-encoder encodes the generated image data by using a H.264 method.

6. The host apparatus of claim 1, wherein the wireless communication method is a 802.11n or 802.11ac method that uses a band of 5 GHz.

7. The host apparatus of claim 1, wherein the communication interface unit receives captured data by using the wireless communication method, the captured data being captured by an imaging unit of the display apparatus,
wherein the generated image data comprises the received captured data.

8. A display apparatus configured to be wirelessly connected to a host apparatus, the display apparatus comprising:
a communication interface unit configured to receive encoded image data from the host apparatus by using a wireless communication method that uses a preset band;
a hardware-decoder configured to decode the received image data;
a user interface (UI) unit configured to display the decoded image data on a touch screen; and
a controller configured to control the communication interface unit to transmit control information corresponding to a control command input through the touch screen to the host apparatus.

9. The display apparatus of claim 8, wherein the wireless communication method is a 802.11n or 802.11ac method that uses a band of 5 GHz.

10. The display apparatus of claim 8, wherein:
the communication interface unit receives the encoded image data and encoded voice data corresponding to the encoded image data; and
the hardware-decoder decodes the encoded image data and the encoded voice data, and the UI unit displays the decoded image data and simultaneously outputs the decoded voice data.

11. The display apparatus of claim 8, further comprising:
an imaging unit configured to capture a subject to generate captured data,
wherein the controller controls the communication interface unit to transmit the generated captured data to the host apparatus by using the wireless communication method when receiving the encoded image data.

12. A method of controlling a host apparatus configured to be wirelessly connected to a display apparatus comprising a touch screen, the method comprising:
receiving control information corresponding to a control command inputted through the touch screen of the display apparatus;
generating image data corresponding to the control information;
encoding the generated image data by a hardware-encoder; and
transmitting the encoded image data to the display apparatus by using a wireless communication method that uses a preset band.

13. The method of claim 12, wherein the generated image data is autonomously encoded without control of a controller of the host apparatus.

14. The method of claim 12, wherein:
the generating of the image data comprises generating the image data and voice data corresponding to the image data as real-time streaming data; and
the encoding of the image data comprises encoding the real-time streaming data.

15. The method of claim 14, wherein the real-time streaming data is HDMI type data.

16. The method of claim 12, wherein the generated image data is encoded by using an H.264 method.

17. The method of claim 12, wherein the wireless communication method is a 802.11n or 802.11ac that uses a band of 5 GHz.

18. The method of claim 12, further comprising:
receiving captured data by using the wireless communication method, the captured data being captured by an imaging unit of the display apparatus,
wherein the generated image data comprises the received captured data.

19. A method of controlling a display apparatus configured to be wirelessly connected to a host apparatus, the method comprising:
receiving encoded image data from the host apparatus by using a wireless communication method that uses a preset band;
decoding the received image data by a hardware-decoder;
displaying the decoded image data on a touch screen; and
transmitting control information corresponding to a control command input through the touch screen to the host apparatus.

20. The method of claim 19, wherein the wireless communication method is a 802.11n or 802.11ac method that uses a band of 5 GHz.

21. The method of claim 19, wherein:
the receiving of the encoded image data comprises:
receiving the encoded image data and encoded voice data corresponding to the encoded image data;
the decoding of the received image data comprises:
decoding the encoded image data and the encoded voice data; and
the displaying of the decoded image data comprises:
displaying the decoded image data and simultaneously outputting the decoded voice data.

22. The method of claim 19, further comprising:
capturing a subject to generate captured data; and
when receiving the encoded image data, transmitting the generated captured data to the host apparatus by using the wireless communication method.

23. A host apparatus configured to be wirelessly connected to a display apparatus, the host apparatus comprising:
a graphic processor to generate image data;
a communication interface unit configured to receive control information corresponding to a control command inputted through a touch screen of the display apparatus;
a controller to control the graphic processor to generate the image data corresponding to the control command; and
an hardware-encoder to encode the generated image data independent of the controller.
